(19) United States
(12) Patent Application Publication
(10) Pub. No.: US 2012/0072982 A1
(43) Pub. Date: Mar. 22, 2012

(54) DETECTING POTENTIAL FRAUDULENT ONLINE USER ACTIVITY

(75) Inventors: Prem Ranganathan, Fremont, CA (US); Yong W. Cha, Sunnyvale, CA (US); Ronald H. Jones, JR., Mountain View, CA (US)

(73) Assignee: Microsoft Corporation, Redmond, WA (US)

(21) Appl. No.: 12/884,385

(22) Filed: Sep. 17, 2010

(51) Int. Cl. G06F 21/00

(52) U.S. Cl. 726/22

(57) ABSTRACT

One or more techniques and/or systems are disclosed herein for identifying potentially fraudulent use of user generated content (UGC) for an online activity by a user. Server-based information and browser-based information associated with the user is identified and used to create a user signature. The user signature is associated with the UGC for the online activity in a cache-key. The cache-key is compared to a desired threshold for identifying potentially fraudulent use of the UGC for the online activity, where potential fraud may be detected if the cache key meets the desired threshold.

### BACKGROUND

Users of online communities often submit user generated content (UGC) on websites, such as when rating products, services, or other online content. For example, a restaurant may have ratings from customers that give a score and some text-based feedback on their experience. Other users of the online community may utilize the ratings as part of a strategy for choosing a particular product or service. For example, if the restaurant has high ratings and/or complimentary text reviews a user may decide to patronize the restaurant. Further, some online communities may utilize polls on certain topics of interest to users, for example, where users vote on particular topics to gauge interest and/or demographics in a particular area.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Online social community generated content, such as product or service ratings and polls can help online consumers to make decisions, for example. Customer engagement can be enhanced if opinions can be trusted and free of fraudulent activity that skews the opinion to unfairly benefit a user, or entity. A perpetrator may be able to repeatedly submit high ratings for a product, for example, thereby ‘gaming’ the system to bubble up the product or service to a highly-rated list. Further, a user (e.g., competitor in the marketplace) may repeatedly submit low ratings for a competitor business, for example, to drive down their overall ratings. These types of fraudulent activities can be hard to detect in scenarios where the user does not need to be authenticated to submit their content (e.g., anonymous users).

Currently, ratings services have very little protection against gaming activity for unauthenticated ratings. A popular solution to address the gaming scenario is to use HTTP cookies to specifically track users and mitigate a single user from masquerading as several distinct users generating content. However, this can be defeated by closing the browser or clearing the browser cookie cache before each data submission. For example, unauthenticated users can rate an item over and over by simply closing their web browser to remove a session cookie. There are other existing solutions that attempt to go beyond using cookies (e.g. using originating IP address) but suffer from a high false positive rate.

Accordingly, one or more techniques and/or systems are disclosed for identifying potentially fraudulent use of user generated content (UGC) for an online activity by a user. A user signature can be created that is specific to a user, such as when working from a specific computer. Repeated occurrences of this user signature for a particular online activity may point to potential gaming activity.

In one embodiment for identifying potentially fraudulent use of user generated content (UGC) for an online activity by a user, server-based information, available from a server running the online service, and browser-based information associated with the user's client can identified and used to create a user signature. The user signature can be associated with the UGC for the online activity in a cache-key, which may be stored in cache. The cache-key can be compared against a desired threshold (e.g., for activity utilizing the same content) that identifies potentially fraudulent use of the UGC for the online activity.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an example method for identifying potentially fraudulent use of user-generated content (UGC) for an online activity by a user.

FIG. 2 is a flow diagram illustrating an example method for identifying potentially fraudulent use of user-generated content (UGC) for an online activity by a user.

FIG. 3 is a component diagram illustrating an example system configured to identify potentially fraudulent use of user-generated content (UGC) for an online activity by a user.

FIG. 4 is a component diagram illustrating an example system configured to identify potentially fraudulent use of user-generated content (UGC) for an online activity by a user.

FIG. 5 is an illustration of an exemplary computer-readable medium comprising processor-executable instructions configured to embody one or more of the provisions set forth herein.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

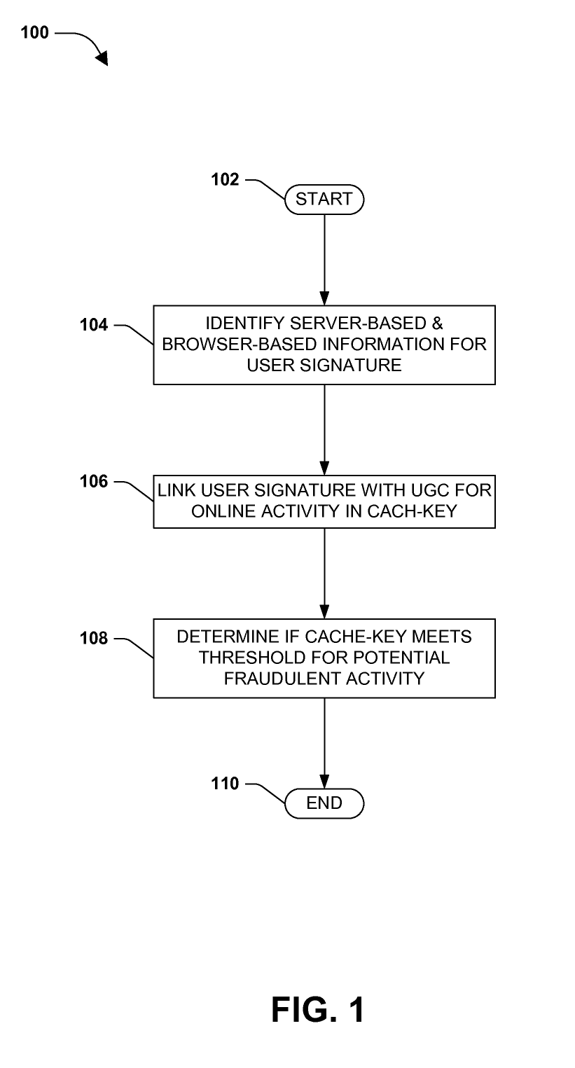

A method may be devised that may be able to determine whether user-generated content (UGC), such as for rating a product or service, comprises fraudulent activity, such as to skew result a particular way. FIG. 1 is a flow diagram of an example method 100 for identifying potentially fraudulent use of UGC for an online activity by a user. The exemplary method 100 begins at 102 and involves identifying server-based information and browser-based information that is associated with the user, which can be used to create a user signature, at 104.

As an illustrative example, when a user attempts to generate UGC on a website (e.g., by uploading data or interacting with site applications) a client used by the user interacts (e.g., communicates) with a server for the website. In one embodiment, server-based information can be information that is available to the server (e.g., that is hosting content, a website, etc.), for example, and can be acquired by the server without querying the client. Such server-based information can comprise an originating Internet protocol (IP) address for the user's client, for example, used by the client to communicate with the server. As an example, a REMOTE_IP header (e.g., or one or more headers defined by HTTP standards) in a request can be used to retrieve the originating IP address of the client machine when it communicates with the server.

Further, the server-based information can comprise a user agent that is used by the user's client. Additionally, the server-based information can comprise an accept headings setting for the user's client. As an example, hypertext transfer protocol (HTTP) may be used by the server to retrieve the user agent and transfer protocol header settings for the client machine, for example, by functioning as a request-response protocol in the client-server model. The user agent can comprise a client application that implements a network protocol when communicating within the client-server system. As an example, a user agent may comprise the browser (e.g., Internet Explorer, Firefox, Opera, etc.) used by the client to navigate to the server.

The transfer header settings can comprise the HTTP accept header field settings, for example, for a request in the browser. For example, HTTP ACCEPT header fields may comprise: ACCEPT; ACCEPT-CHARSET; ACCEPT-ENCODING, ACCEPT-LANGUAGE, and ACCEPT-RANGES. The settings for these headings can be used for creating the user signature, for example, but the transfer protocol header settings are not merely limited to these embodiments. For example, a plurality of other HTTP header fields are available from which settings may be retrieved, such as CONTENT headers (e.g., in a response).

It will be appreciated that the server-based information is not limited to the embodiments described herein. For example, cookies, super-cookies, persistent cookies (e.g., multiple unit identities (MUIDs) and/or access network identifiers (ANIDs)), use of X-forwarded for (XFF) HTTP headers (e.g., to identify an originating IP address behind a proxy server), port numbers, and/or other information may also be server-based information associated with the user that can be used to create a user signature.

In one embodiment, browser-based information can comprise information that is available in the browser (e.g., used to navigate to the website), for example, and the information may be acquired by the server when querying the client. Such client-based information can comprise browser plug-in information for plug-ins that may be installed on the user's client. A browser plug-in can comprise software components (e.g., programs) that provide additional functionality to the browser (e.g., that enable customizing functionality of the browser when supported).

Browser-based information can further comprise a time zone for the user's client, and/or a screen resolution for the user's client. That is, for example, the time zone in which the client machine is being operated can be determined, along with a screen size and color depth (e.g., comprising screen resolution). In one embodiment, such browser-based information can be retrieved from the client by utilizing one or more types of client-side programmatic scripts. For example, if a particular type of script is enabled on the client machine, that script running on the client accessing a webpage can be used to retrieve these values. It will be appreciated that any one or more scripting languages used to enable programmatic access to computational objects in a host environment can be utilized to retrieve the desired values for the browser-based information.

In the exemplary method 100, at 106, the user signature is linked with the UGC for the online activity in a cache-key. A cache key can comprise a key (e.g., as a type of address) that is used to find a specific cache (e.g., location of cached data), for example, in a manner similar to how key fields may be used to find specific records in a database. As an illustrative example, a cached object (e.g., a web-page cached in memory) may comprise the cached data and a cache key (e.g., webpage name), which can be used to find the cached object comprising the cached data (e.g., data in the webpage).

In one embodiment, the user signature and UGC can be comprised in the cache key, linking them together in the cache key. In another embodiment, the cache key can comprise the user signature, a content ID for the UGC and a UGC value. In this embodiment, the user signature, UGC value and content ID can be combined as a tuple, for example, for the cache key.

In one embodiment, the UGC value can represent a number of times the UGC is linked with the user signature for the online activity. That is, for example, the UGC value may indicate a value of two if the UGC has been linked with the user signature for the online activity two times. In one embodiment, the UGC value may initiate at zero and increment by one for respective times the UGC and user signature are linked for the online activity (e.g., each time the user attempts to vote in an online poll). Therefore, for example, when the UGC value is incremented it may be analogous to the cache key being incremented as the UGC value is comprised in the cache key.

At 108, in the exemplary method 100, the cache key is compared against a desired threshold that indicates potential fraudulent use of the UGC for the online activity. If it is determined that the cache key meets the desired threshold (e.g., meets or exceeds the threshold), the UGC for the user can be identified as a potentially fraudulent attempt to “game” the online activity, for example, and the UGC can be discarded (e.g., or not entered for the online activity).

As an illustrative example, a user may attempt to rate a product or service multiple times in order to “game” the online ratings to provide an appearance that the product or service is rated higher (or lower) than it might otherwise be rated. In this example, the user rating can comprise the UGC for the online activity of applying ratings at a site that rates products or services. Here, if it is determined that the cache key meets the desired threshold, it may mean that the user has attempted to rate the same product more than once, for example (e.g., the cache key has a UGC value of one, and the threshold is one, and thus a subsequent “vote” by the user may be ignored because the threshold of one would be exceeded).

Having determined if the cache key meets the desired threshold, the exemplary method 100 ends at 110.

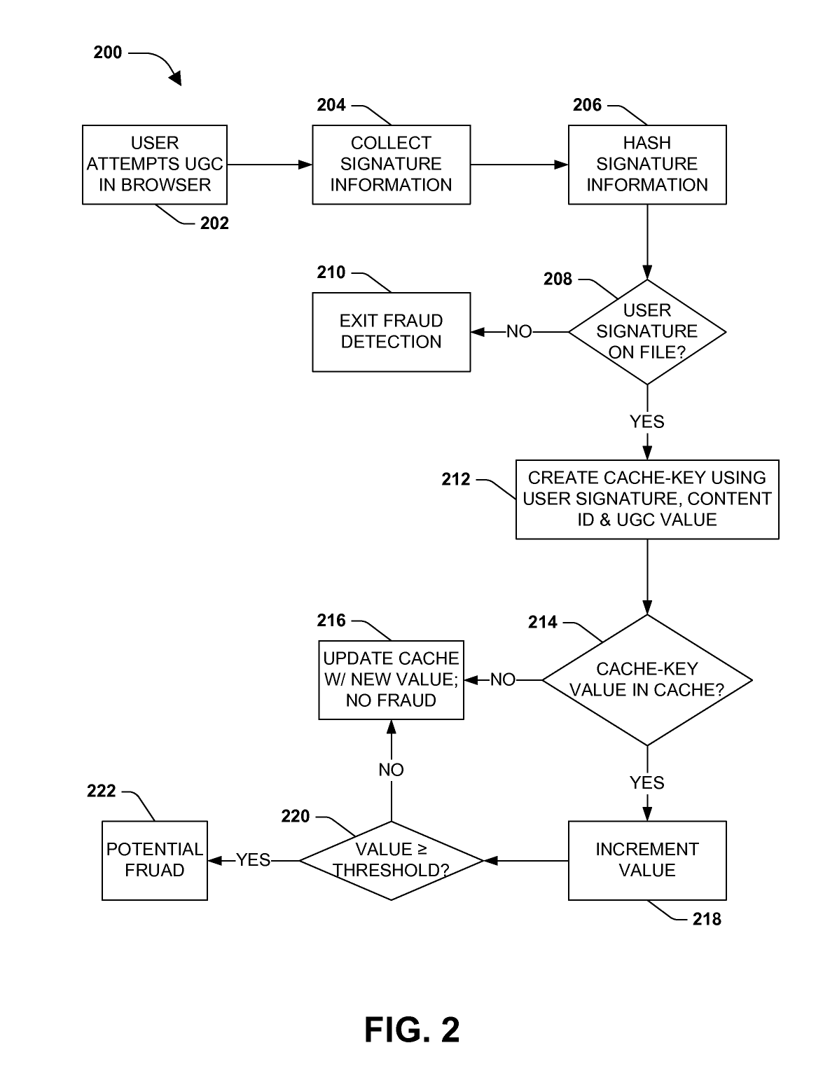

FIG. 2 is a flow diagram illustrating one embodiment 200 of one or more methods described herein. At 202, a user attempts to create user generated content (UGC) in a browser instantiated on a client machine. For example, a website may provide for users to vote in an online poll (e.g., for the best local restaurant). In this example, the user can use their browser on their computer to interact with the online poll on the website by voting, thereby generating UGC for the poll (e.g., online activity).

At 204, user signature information can be collected. As described above, user signature information can comprise server-based information (e.g., collected from the server) and browser-based information (e.g., collected from the user's browser). As an example, the user's originating IP address (e.g., user's client), the user agent (e.g., browser), and/or header settings for the transfer protocol (e.g., accept header setting for HTTP) can be collected from the server. Further, the browser can be requested to identify the browser plug-ins installed on the client, the time zone of the client, and/or the screen resolution (e.g., color depth and/or screen size) for the client, for example. In one embodiment, a particular type of script requesting may be utilized to collect the browser-based information.

However, in one embodiment, if a particular type of script is not enabled in the browser, merely the server-based information can be used to create the user signature. As an illustrative example, the client signature is used to link the client machine with the UGC. Having more information can increase fidelity of the user signature, thereby decreasing potential false positives, for example. However, creating the user signature without using the browser-based information may not have a significant effect on the false-positives (e.g., no significant increase in false positives), for example.

At 206 in the example embodiment 200, one or more elements of the user signature information (e.g., respective server-based and browser-based information), can be hashed to create the user signature. In one embodiment, a simple integer ASCII code hash can be created using the combination of elements from the browser-based information. For example, a hash function can reinterpret the data as an integer in binary notation for the hashed value, such as by mapping character strings to their binary representations, to create a hash of the browser-based information (e.g., a client hash).

In another embodiment, all or some of the server-based information can be hashed either separately or together with the browser-based information. For example, the server-based information may be combined with the hash of the browser-based information and a hash of the combined information can be created, such as by performing a Merkel-Damgard hashing algorithm, such as an MD4 or MD5 encryption algorithm, which are often used to hash data values having long or variable character strings. As a further example, an MD5 hash can be performed on the combined IP address; HTTP user agent; HTTP accept header; and client hash for the user. In this example, the resulting hash can be used as the user signature for the user's client.

For example, due to a potential large size of the elements of the user signature they can be converted to a 128-bit representation (e.g., a hash), such as by using a Merkel-Damgard construction, such as the MD5 encryption algorithm (e.g., or some other hashing algorithm). In this example, the hashed elements of the user signature information may also be converted in a 32-byte hexadecimal value, thereby allowing the user signature to be specific to the user without having to store a large amount of information.

It will be appreciated that the techniques described herein are not limited merely to the example hash functions described herein. For example, other hash functions may be used to create the user signature, and other combinations of user signature data may be hashed in different combinations. For example, the user signature data may be hashed together using a trivial hash function, or a portion of the user signature data can be hashed, then a combination of hashes and user signature information may be subjected to a second hash algorithm, such as a SHA-1, SHA-1, or SHA-2 hash algorithm.

At 208, the user signature can be searched against existing, stored user signatures to determine if the user signature is on file. For example, when a user accessed an online service that comprises user interactions where UGC can be generated, such as for ratings or polls, the corresponding user signature can be stored in a database. In this example, if the user signature generated at 206 does not appear in the existing signature database, it can be assumed that the user has not attempted to generate UGC for the service, and is not attempting potential fraudulent use of the UGC. Therefore, if the user signature is not on file, at 208, the fraud detection service can be exited at 210.

If the user signature is on file (e.g., in the database of existing user signatures), at 208, a cache-key can be created using the user signature, a content ID for the UGC, and a UGC value, at 212. As described above, in one embodiment, a tuple comprising the user signature (e.g., as a hash), an ID for the content (e.g., a simple ID associated with the UGC for the online activity), and a UGC value can be created. In one embodiment, the UGC value can be initiated at zero, and an ID can be selected for the UGC (e.g., a descriptor associated with the online activity, a random ID value, etc.). In this way, for example, the cache key (e.g., comprising the tuple) has a user signature specific to the user's client, a content ID specific to the UGC for the online activity, and a counter that identifies how many times the user has attempted to generate the UGC for the online activity.

AT 214, the cache key can be searched in cache (e.g., memory) to determine if a cached object is present for the cache key. If the cache key does not identify a cached object (e.g., the tuple is not stored in cache), at 214, the cache can be updated with a new UGC value (e.g., one, corresponding to a first attempt to use the UGC for the online activity), and potentially fraudulent activity is not detected, at 216. If the cached object is present for the cache key, at 214, the existing UGC value can be incremented (e.g., increased by one, such as from one to two) to a next value, at 218.

At 220, the UGC value (recently incremented) can be compared against a desired threshold value. In one embodiment, determining whether the cache-key meets a desired threshold can comprise determining whether the UGC value meets the desired threshold. For example, a desired threshold may comprise a value associated with the user using the UGC for the online activity twice (e.g., two). In this example, the online activity may comprise the user attempting to rate a same service, in order to inflate the rating, and the rating service may have a policy that merely allows the users to submit one rating per service. Therefore, at 220, if the UGC value meets or exceeds the threshold (e.g., two) potentially fraudulent activity is detected, at 222.

If the UGC value for the cache key does not meet or exceed the desired threshold, at 220, the cache can be updated with the new UGC value (recently incremented) for the cache key. Therefore, for example, when the combination of the user signature and content ID is identified subsequently they will be associated with the newly updated UGC value, which can identify how many times the user previously attempted to submit the UGC for the online activity. In this example, if the subsequent attempt to submit the UGC meets or exceeds the threshold for fraudulent activity, the user may be prevented from submitting the UGC for the online activity.

In one aspect, identification of the potentially fraudulent UGC submittal for an online activity can be performed in real-time (e.g., on-the-fly at a time of submittal by user)) and/or offline (e.g., after submittal of the UGC by the user). In one embodiment, potentially fraudulent use of the UGC for the online activity can be identified in real-time by using data stored in memory cache. That is, for example, transient memory may be used to store the cache keys for UGCs for an online activity (e.g., on a server for a particular part of an online service, such as a poll). In this example, newly created cache keys can be compared in real-time against the cache to identify potential fraudulent activity, as described above. In this way, for example, the UGC that is identified as potentially fraudulent can be prevented from being submitted or used for the online activity before it may affect the activity.

In another embodiment, in this aspect, potentially fraudulent use of the UGC for the online activity can be identified offline using data stored in persistent storage. For example, while the in memory cache may comprise temporary storage of cache keys (e.g., comprising a day or two of cache keys), persistent storage (e.g., non-transient memory, such as disks) can store weeks, months or years worth of cache keys, as desired. In this way, in this example, previously submitted UGC for an online activity can be compared against data stored in the persistent storage offline (e.g., at a time after submittal of the UGC), such as to identify potentially fraudulent activity patterns that were not identified in real-time. Offline identification of potentially fraudulent activity may be used to improve real-time detection, for example, by identifying previously unknown patterns.

In another aspect, there are different ways to respond to potential fraudulent activity. In one embodiment, when potential fraudulent activity is identified, the user can be provided with information that indicates a successful fraudulent affectation of the online activity. That is, for example, a user may attempt to submit a plurality of ratings for a product or service, or vote a number of times in an online poll. In this embodiment, the service comprising the online activity can provide the user with information in their browser that show they have affected the ratings or the polls in accordance with the plurality of submittals or votes. Therefore, in this example, the user may see that when they submit a plurality of votes the vote count for their choice increases accordingly. However, in this embodiment, the actual UGC can be discarded (e.g., not recorded or saved) for the online activity, thus not alerting the perpetrator that their attempt to skew results has been thwarted.

In another embodiment, when potentially fraudulent activity is detected for the online activity, the UGC can be discarded immediately. In this embodiment, the user can be notified and/or the outcome can display that their UGC has not affected the online activity (e.g., no vote counted). In another embodiment, such as where the potentially fraudulent UGC is detected offline, the user's account may be deactivated or the client identified by the user signature may be banned from accessing the service. Further, when offline fraud is detected, the real-time detection may be improved by updating a type of UGC value to one that facilitates detecting the fraudulent activity.

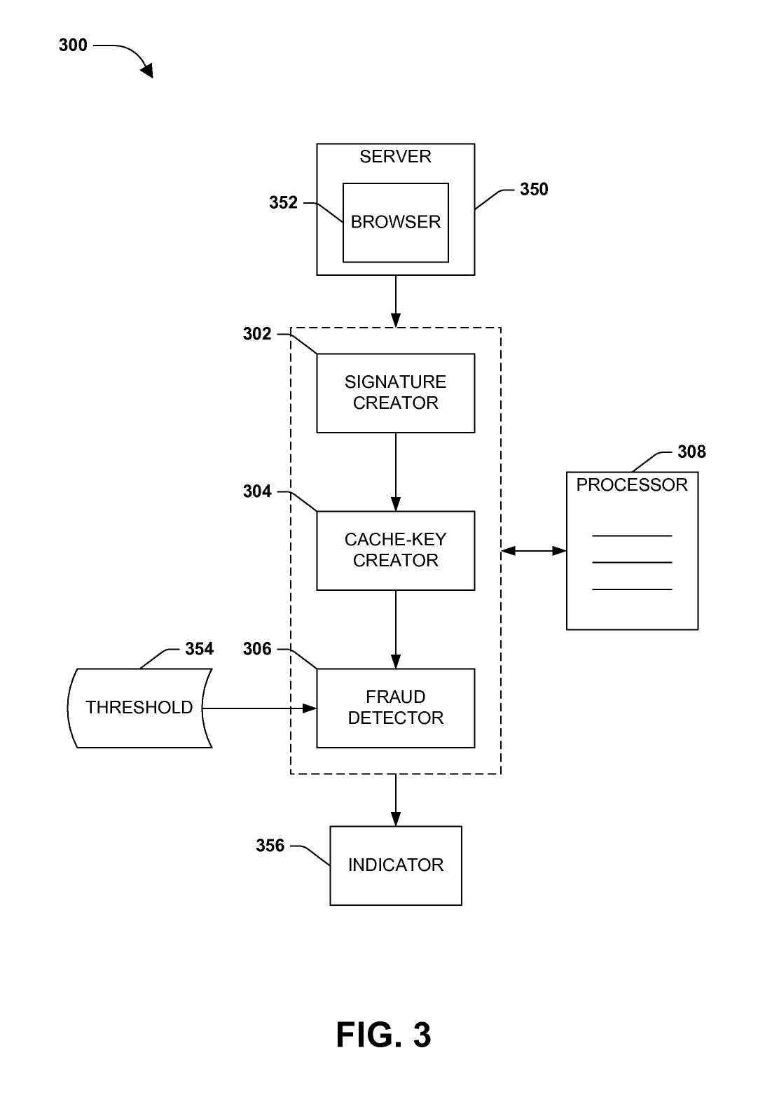

A system may be devised that can help detect when a user may attempt to “game” a service, such as by continually submitting UGC for a same online activity, for example. FIG. 3 is a component diagram of an exemplary system 300 for identifying potentially fraudulent use of user generated content (UGC) for an online activity by a user. A signature creation component 302 is configured to create a user signature using information identified from a server 350 and/or information identified from a browser 352, which may be interacting with the server 350. The browser-based information and server-based information are associated with a particular user, such as using a particular client machine (computer) to submit the UGC for the online activity.

A cache-key creation component 304 is configured to link the user signature with the UGC for the online activity in a cache-key. For example, the cache-key creation component 304 can combine the user signature with a content ID for the UGC into a cache key. In this way, in this example, the cache key will be linked to the UGC for the online activity stored in cache (e.g., in-memory cache). In one embodiment, a UGC value can also be linked with the user signature and content ID by the cache-key creation component 304, where the UGC value indicates a number of times the user has attempted to submit the UGC for the online activity, for example.

A fraud detection component 306 is configured to compare the cache-key with a desired threshold 354 in order to identify potential fraudulent use of the UGC for the online activity. The fraud detection component 306 utilizes a processor 308 to perform the comparison of the cache-key with the threshold 354. In one embodiment, the fraud detection component 306 may detect a potential fraudulent use of the UGC for the online activity if the UGC value in the cache-key meets or exceeds the threshold 354. For example, if the cache-key indicates that the UGC is being submitted for the online activity for a fourth time, and the threshold is four, the fraud detection component 306 may indicate potential fraudulent use of the UGC on some type of indicator (e.g., flashing light) 356 based on the detection. Further, the system may take additional actions, such as discarding the UGC for the online activity.

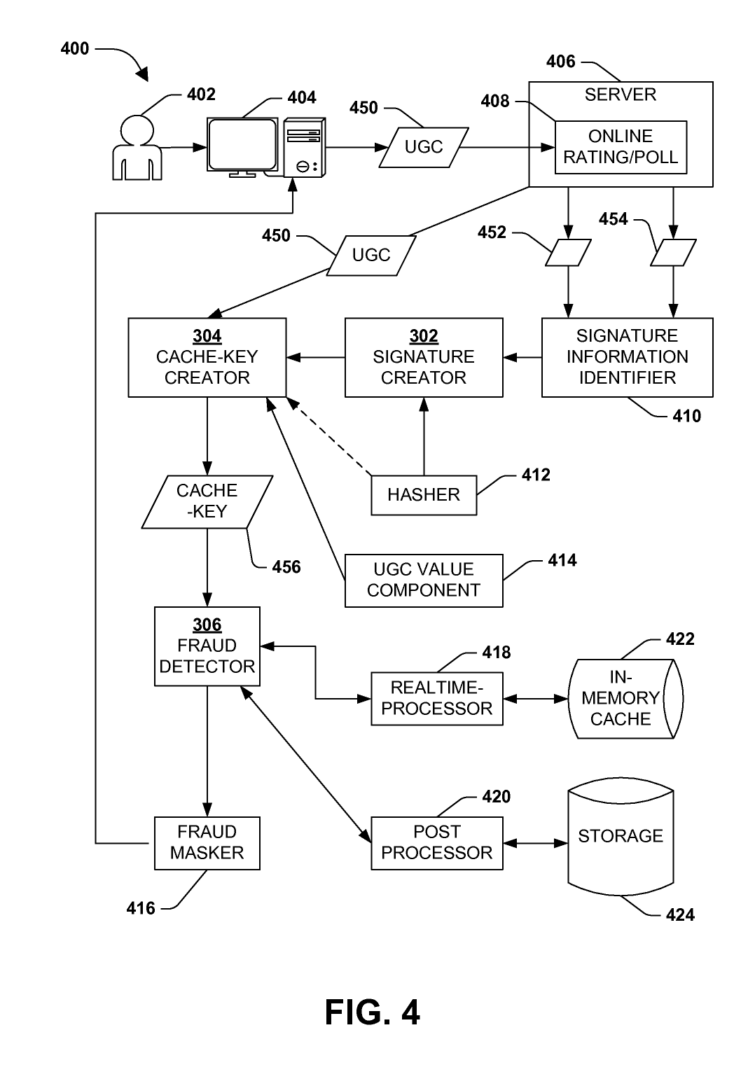

FIG. 4 is a component diagram of an example embodiment 400 of one or more components of one or more systems described herein. In this example 400, a user 402 may be submitting UGC 450 for an online activity using their computer 404, where the online activity 408 comprises a rating of a product, service, or online content, and/or an online poll. The UGC 450 is submitted to a server 406 using a browser instantiated on the user's computer 404, such as by selecting a rating or poll answer, and/or uploading text in a rating description.

A signature information identification component 410 indentifies the server-based information 452 and browser-based information 454 associated with the user 402, from the user's computer 404. In one embodiment, the server-based information 452 can comprise: an originating Internet protocol (IP) address for the user's client 404 (computer); a user agent (e.g., browser) that is used by the user's client 404; and/or a transfer protocol header setting (e.g., HTTP accept header settings) for the user's client 404. The signature information identification component 410 may use hypertext transfer protocol (HTTP) requests to retrieve the information using the server 406, for example.

Further, in one embodiment, the browser-based information 454 can comprise: browser plug-in information (e.g., plug-in applications) for the user's client 404; a time zone for the user's client 404; and/or a screen resolution (e.g., screen size and color depth) for the user's client 404. As an example, the signature information identification component 410 may use a particular script to retrieve the information from the browser. However, in one embodiment, if such a script is not enabled in the browser, the signature information identification component 410 may merely retrieve the server-based information.

As described above, the signature creation component 302 can create the user signature from the server-based information 452 and browser-based information 454. In one embodiment, a hashing component 412 can hash the identified server-based 452 and browser-based information 454 that is associated with the user to create the user signature. That is, for example, the hashing component 412 may use one or more hashing algorithms (e.g., together or in sequence) to generate a hash (e.g., comprising a value) from the retrieved user signature information.

In this example 400, the cache-key creation component 304 can combine the user signature, a UGC value and a content ID for the UGC 450, associated with the online activity, as a tuple. The tuple can comprise the cache-key 456, which may be stored in memory 422. In one embodiment, the tuple may be hashed by the hashing component 412 to create the cache-key 456. A UGC value component 414 maintains a UGC value for the cache-key 456, where the UGC value indicates a number of times the UGC is linked with the user signature for the online activity.

As described above, the fraud detection component 306 can compare the cache-key to a threshold, such as by comparing the UGC value to the threshold, to determine if the UGC comprise a potentially fraudulent attempt at “gaming” the online activity. In one embodiment, a real-time processing component 418 can store real-time data, such as the cache-key, in memory cache 422 for real-time identification of potential fraudulent use of the UGC for the online activity. In another embodiment, a post-processing component 420 can store data in persistent storage 424 for offline identification of potential fraudulent use of the UGC for the online activity.

In another embodiment, a fraud masking component 416 can provide the user 4102 with information indicative of a successful fraudulent use of the UGC for the online activity. For example, the fraud masking component 416 can provide a version of the service to the user's client 404 that shows that the potentially fraudulent activity (e.g., excess ratings or votes) actually worked. In this example, the indication may be in the form of showing the UGC in the service, and/or changing the polls or ratings to indicate that the UGC was actually submitted. However, in one embodiment, the service may actually discard the UGC if potential fraudulent activity is indicated.

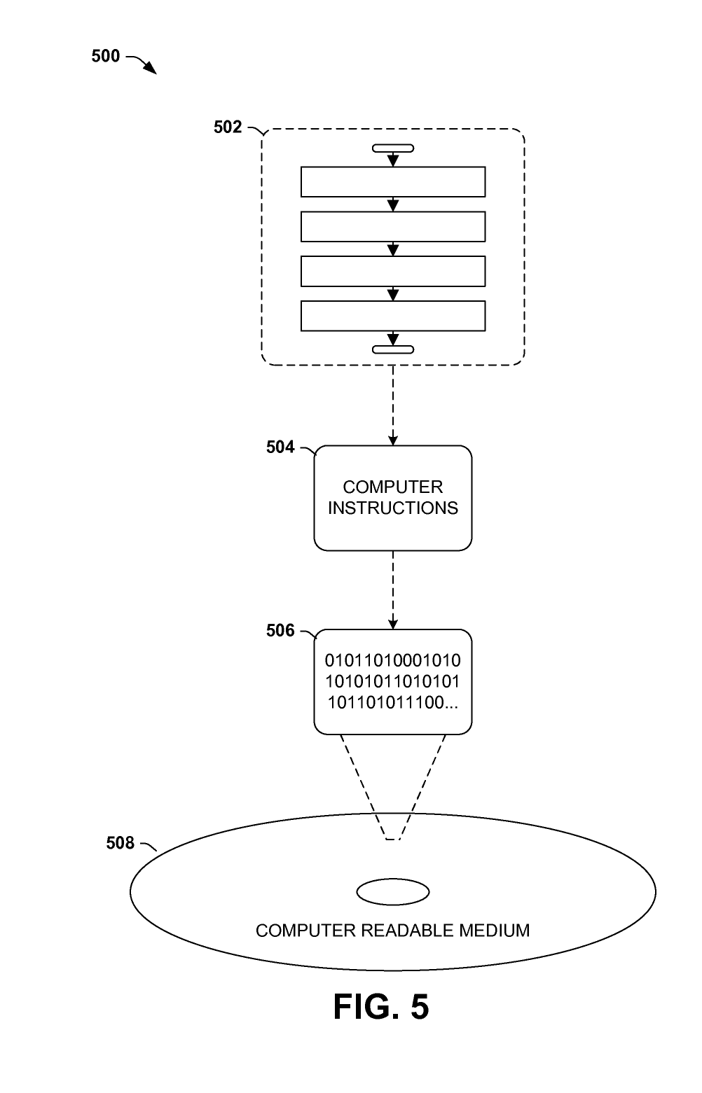

Still another embodiment involves a computer-readable medium comprising processor-executable instructions configured to implement one or more of the techniques presented herein. An exemplary computer-readable medium that may be devised in these ways is illustrated in FIG. 5, wherein the implementation 500 comprises a computer-readable medium 508 (e.g., a CD-R, DVD-R, or a platter of a hard disk drive), on which is encoded computer-readable data 506. This computer-readable data 506 in turn comprises a set of computer instructions 504 configured to operate according to one or more of the principles set forth herein. In one such embodiment 502, the processor-executable instructions 504 may be configured to perform a method, such as the exemplary method 100 of FIG. 1, for example. In another such embodiment, the processor-executable instructions 504 may be configured to implement a system, such as the exemplary system 300 of FIG. 3, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

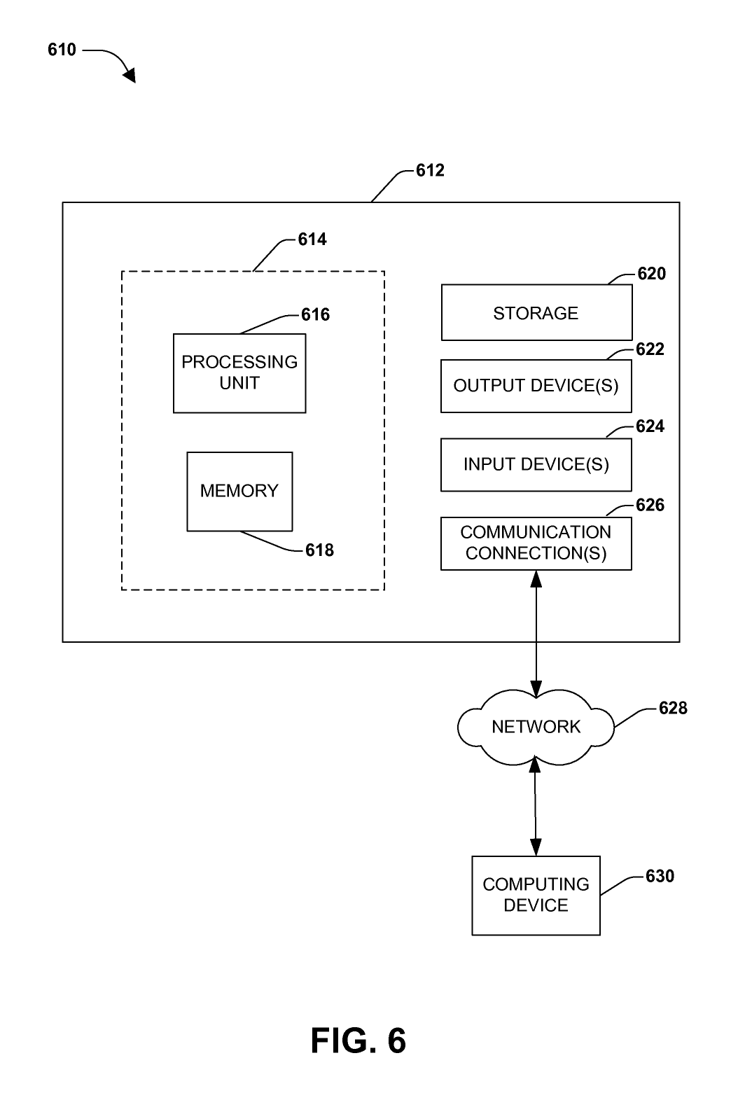

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 610 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for identifying potentially fraudulent use of user generated content (UGC) for an online activity by a user, comprising:
identifying server-based and browser-based information associated with the user, used to create a user signature;
linking the user signature with the UGC for the online activity in a cache-key; and
determining whether the cache-key meets a desired threshold for identifying potentially fraudulent use of the UGC for the online activity using a computer-based processor.

2. The method of claim 1, identifying server-based information comprising identifying one or more of:
an originating Internet protocol (IP) address for the user's client;
a user agent used by the user's client; and
a transfer protocol header setting for the user's client.

3. The method of claim 1, identifying browser-based information comprising identifying one or more of:
browser plug-in information for the user's client;
a time zone for the user's client; and
a screen resolution for the user's client.

4. The method of claim 1, comprising creating a user signature comprising hashing one or more portions of:
the server-based information; and
the browser-based information.

5. The method of claim 4, comprising:
hashing the browser-based information; and
hashing a combination of the hashed browser-based information and the server-based information to generate the user signature.

6. The method of claim 1, linking the user signature with the UGC comprising combining the user signature, a UGC value and a content ID associated with the online activity as a tuple.

7. The method of claim 1, comprising associating a UGC value with the cache-key, where the UGC value comprises a number of times the UGC is linked with the user signature for the online activity.

8. The method of claim 7, determining whether the cache-key meets a desired threshold comprising determining whether the UGC value meets the desired threshold.

9. The method of claim 1, comprising one or more of:
identifying potentially fraudulent use of the UGC for the online activity in real-time utilizing data stored in memory cache; and
identifying potentially fraudulent use of the UGC for the online activity offline utilizing data stored in persistent storage.

10. The method of claim 1, when potential fraudulent activity is identified, comprising providing the user with information indicative of a successful fraudulent affectation of the online activity.

11. A system for identifying potentially fraudulent use of user generated content (UGC) for an online activity by a user, comprising:
a computer-based processor;
a signature creation component configured to create a user signature using identified server-based and browser-based information associated with the user;
a cache-key creation component configured to link the user signature with the UGC for the online activity in a cache-key; and
a fraud detection component configured to compare the cache-key with a desired threshold to identify potential fraudulent use of the UGC for the online activity using the processor.

12. The system of claim 11, the online activity comprising one or more of:
a rating of a product, service, or online content; and
an online poll.

13. The system of claim 11,
the server-based information comprising one or more of:
an originating Internet protocol (IP) address for the user's client;
a user agent used by the user's client; and
a transfer protocol header setting for the user's client; and
the browser-based information comprising one or more of:
browser plug-in information for the user's client;
a time zone for the user's client; and
a screen resolution for the user's client.

14. The system of claim 11, comprising a signature information identification component configured to indentify the server-based and browser-based information associated with the user.

15. The system of claim 11, the cache-key creation component configured to combine the user signature, a UGC value and a content ID associated with the online activity as a tuple.

16. The system of claim 11, comprising a UGC value component configured to maintain a UGC value for the cache-key, where the UGC value indicates a number of times the UGC is linked with the user signature for the online activity.

17. The system of claim 11, comprising a hashing component configured to hash one or more of:
the identified server-based and browser-based information associated with the user to create the user signature; and
a tuple comprising the user signature, a UGC value and a content ID associated with the online activity to create the cache-key.

18. The system of claim 11, comprising one or more of:
a real-time processing component configured to store real-time data in memory cache for real-time identification of potential fraudulent use of the UGC for the online activity; and
a post-processing component configured to store data in persistent storage for offline identification of potential fraudulent use of the UGC for the online activity.

19. The system of claim 11, comprising a fraud masking component configured to provide the user with information indicative of a successful fraudulent use of the UGC for the online activity.

20. A method for identifying potentially fraudulent use of user generated content (UGC) for an online activity by a user, comprising:
identifying server-based and browser-based information associated with the user;
creating a user signature comprising hashing the identified server-based and browser-based information;
creating a cache-key for the UGC associated with the online activity, comprising:
combining the user signature, a content ID associated with the online activity and a UGC value comprising an indication of a number of times the UGC is associated with the user signature for the online activity into a tuple; and
hashing the tuple to generate the cache-key; and
identifying whether the cache-key has been previously stored; and
if the cache-key has been previously stored, determining whether the UGC value meets a desired threshold using a computer-based processor.
